(19) United States
(12) Patent Application Publication
(10) Pub. No.: US 2025/0104135 A1
(43) Pub. Date: Mar. 27, 2025

(54) VIRTUAL FITTING APPARATUS AND VIRTUAL FITTING PROGRAM

(71) Applicant: ASICS CORPORATION, Kobe-shi (JP)

(72) Inventors: Masayuki TSUTSUI, Hyogo (JP); Shingo TAKASHIMA, Hyogo (JP); Satoru ABE, Hyogo (JP); Genki HATANO, Hyogo (JP); Yuya KOZUKA, Hyogo (JP); Lingyu HSU, Hyogo (JP); Ryo KAMIYA, Hyogo (JP)

(21) Appl. No.: 18/894,120

(22) Filed: Sep. 24, 2024

(30) Foreign Application Priority Data
Sep. 25, 2023 (JP) 2023-161661

(51) Int. Cl. G06Q 30/0601; A63B 24/00; G06Q 30/0203; G06T 13/40

(52) U.S. Cl. CPC G06Q 30/0643; A63B 24/0006; A63B 24/0062; G06Q 30/0203; G06T 13/40

(57) ABSTRACT

A virtual fitting apparatus is provided with a user information acquiring unit, a wearing item information acquiring unit, a prediction condition acquiring unit, a prediction unit, and an output unit. The user information acquiring unit acquires physical information on a user. The wearing item information acquiring unit acquires wearing item information related to characteristics of a predetermined wearing item. The prediction condition acquiring unit acquires, as a prediction condition, information related to a situation in which a predetermined exercise is performed. The prediction unit predicts, based on the physical information, the wearing item information, and the prediction condition, a user state resulting when the user does the predetermined exercise by wearing the predetermined wearing item. The output unit outputs information related to the predicted user state.

### CROSS-REFERENCE TO RELATED APPLICATION

This application claims priority to Japanese Patent Application No. 2023-161661, the disclosures of which are incorporated herein by reference in their entirety.

### BACKGROUND

### Technical Field

The present disclosure relates to, for example, a virtual fitting apparatus and a virtual fitting method.

### Background Information

There is known a virtual fitting technique of generating a composite image of a user wearing a wearing item such as clothes, thereby allowing the user to virtually experience the fitting even without wearing the wearing item. For example, JP 2006-249618 A describes a technique of using information on the movement of a person to be fitted for trial fitting to estimate the movement of clothes to be made when the person to be fitted wears the clothes, and combining an image of the clothes making the estimated movement with a moving image of the person to be fitted. Thus, the technique described in JP 2006-249618 A presents, to the person to be fitted, a video image with movements that is close to a state in which the person to be fitted has worn the actual clothes.

### SUMMARY

However, the technique described in JP 2006-249618 A does not consider in what situation an exercise is performed when the person to be fitted wears the wearing item. Therefore, there is room for improvement in the evaluation of the wearing item.

The present disclosure has been conceived in view of such circumstances, and an object of the present disclosure is to provide a virtual fitting technique whereby it is possible to accurately evaluate a wearing item.

A virtual fitting apparatus of an aspect of the present disclosure is provided with: a user information acquiring unit which acquires physical information on a user; a wearing item information acquiring unit which acquires wearing item information related to characteristics of a predetermined wearing item; a prediction condition acquiring unit which acquires, as a prediction condition, information related to a situation in which a predetermined exercise is performed; a prediction unit which predicts, on the basis of the physical information, the wearing item information, and the prediction condition, a user state resulting when the user does the predetermined exercise by wearing the predetermined wearing item; and an output unit which outputs information related to the user state.

Another aspect of the present disclosure is a virtual fitting program. The program causes a computer to implement: a function of acquiring physical information on a user; a function of acquiring wearing item information related to characteristics of a predetermined wearing item; a function of acquiring, as a prediction condition, information related to a situation in which a predetermined exercise is performed; a function of predicting, on the basis of the physical information, the wearing item information, and the prediction condition, a user state resulting when the user does the predetermined exercise by wearing the predetermined wearing item; and a function of outputting information related to the user state.

Note that arbitrary combinations of the above constituent elements, and those obtained by mutually replacing the constituent elements and expressions of the present invention among a method, an apparatus, a program, a transitory or non-transitory storage medium storing therein a program, and a system are also valid as the aspects of the present invention.

According to an aspect of the present disclosure, it is possible to provide a virtual fitting technique whereby a wearing item can be accurately evaluated.

### BRIEF DESCRIPTION OF THE DRAWINGS

FIG. 1 is a schematic diagram showing an outline of a virtual fitting system.

FIG. 2 is a functional block diagram showing a schematic configuration of the virtual fitting system.

FIG. 3 is a functional block diagram showing a schematic configuration of an arithmetic portion of a virtual fitting server.

FIG. 4 is a functional block diagram showing a schematic configuration of a user information acquiring unit.

FIG. 5 is a functional block diagram showing a schematic configuration of a prediction unit.

FIG. 6 shows an example of a menu screen of a virtual fitting mode.

FIG. 7 shows an example of a user information input screen.

FIG. 8 shows an example of a selection screen for a face image included in an avatar.

FIG. 9 shows an example of a selection screen for selecting a target wearing item.

FIG. 10 shows an example of a display screen which displays an avatar image.

FIG. 11 shows an example of a display screen which displays an avatar image.

### DETAILED DESCRIPTION

In the following, embodiments will be described with reference to the drawings. In the embodiments and modifications, the same or equivalent constituent elements are denoted by the same reference numerals, and duplicated description thereof will be omitted as appropriate.

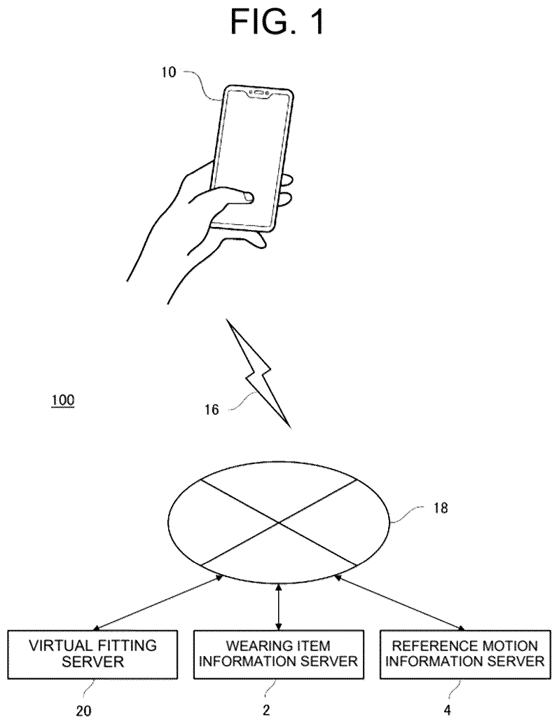

FIG. 1 is a schematic diagram showing an outline of a virtual fitting system 100. The virtual fitting system 100 mainly includes a user terminal 10 and a virtual fitting server 20. The virtual fitting system 100 may further include a wearing item information server 2, or the function of the wearing item information server 2 may be built within the virtual fitting server 20. Similarly, the virtual fitting system 100 may further include a reference movement information server 4, or the function of the reference movement information server 4 may be built within the virtual fitting server 20. The constituent elements provided in the virtual fitting system 100 are connected to each other via wireless communication 16 and a network 18.

Each of the user terminal 10 and the virtual fitting server 20 may be configured by a mobile terminal or a computer composed of a central processing unit (CPU), a graphics processing unit (GPU), a random-access memory (RAM), a read-only memory (ROM), an auxiliary storage device, a display device, a communication device, and the like, and a program stored in the mobile terminal or the computer. For example, the configuration may be realized in such a form that a program executed by the virtual fitting server 20 is used by the user terminal 10 via the network 18. Alternatively, the configuration may be one in which the function of a virtual fitting system is realized by an apparatus of a single body having both the functions of the user terminal 10 and the virtual fitting server 20, and the user can execute a virtual fitting program by directly operating the apparatus. The apparatus of a single body may be a personal computer, a mobile terminal such as a smartphone, or an information terminal such as a tablet terminal. Further, the apparatus of a single body may be realized in the form of a terminal, which is installed in a store that sells wearing items and is operated by an assistant, i.e., a sales clerk, and a program stored in the terminal.

In the present specification, a “virtual fitting apparatus” may refer to the virtual fitting system 100 as a whole or to the virtual fitting server 20. In the present embodiment, since the configuration is realized in such a way that many of the characteristic functions included in the “virtual fitting apparatus” are provided in the virtual fitting server 20, the virtual fitting server 20 substantially corresponds to the “virtual fitting apparatus”. However, the characteristic functions of the “virtual fitting apparatus” may be decentralized between the user terminal 10 and the virtual fitting server 20, or the configuration may be realized in such a way that many of the functions are assigned to the user terminal 10.

Referring to FIG. 1, an example of the operation of the virtual fitting system 100 will be described. The user uses the user terminal 10 to input physical information on the user himself/herself, designation information of a wearing item that the user wishes to virtually try on (hereinafter referred to as a “target wearing item”), and information related to a situation in which exercise (hereinafter referred to as a “target exercise”), which is assumed to be performed by wearing the target wearing item, is performed. The designation information of the target wearing item is, for example, product number information of the target wearing item. The information related to the situation in which the target exercise is performed is used as a prediction condition for predicting a user state, which will be described later.

The user terminal 10 transmits, via the wireless communication 16 and the network 18, the physical information on the user, the designation information of the target wearing item, and the prediction condition to the virtual fitting server 20. The virtual fitting server 20 acquires information related to characteristics of the target wearing item (hereinafter referred to as “wearing item information”) from the wearing item information server 2. The virtual fitting server 20 predicts the user state resulting when the user does the target exercise by wearing the target wearing item on the basis of the acquired physical information, wearing item information, and prediction condition. For example, in a case where the target exercise is running, the user state includes information such as air permeability of the target wearing item, a load on the body, and the like.

The virtual fitting server 20 models an avatar on the basis of the physical information on the user. The virtual fitting server 20 generates an avatar image in which the predicted user state is reflected in the modeled avatar. The virtual fitting server 20 transmits the generated avatar image to the user terminal 10. The user terminal 10 displays the received avatar image. As described above, the virtual fitting system 100 can display the user state resulting when the user does a predetermined exercise by wearing a predetermined fitting item by reflecting the user state in the avatar modeled on the basis of the physical information on the user.

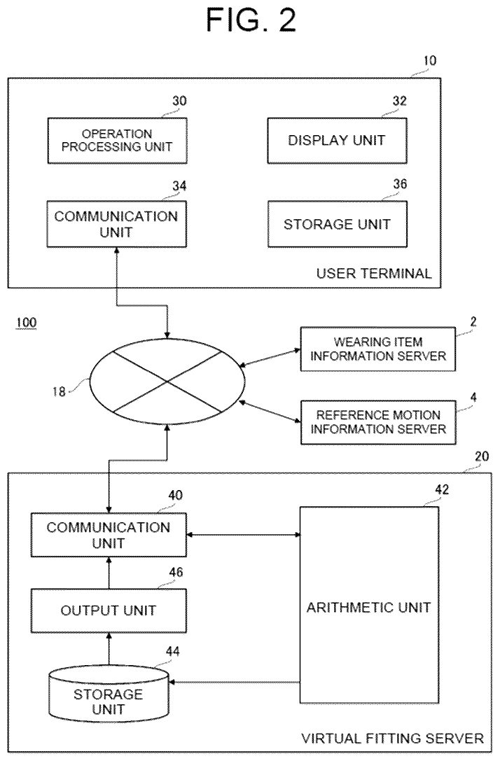

FIG. 2 is a functional block diagram showing a schematic configuration of the virtual fitting system 100. Each functional block illustrated in each of the figures including FIG. 2 can be realized by an element or a mechanical device such as a processor or a memory of a computer, as hardware, and can be realized by a computer program or the like, as software. Here, functional blocks realized in cooperation thereof are illustrated. These functional blocks can be realized in various forms by hardware, software, or a combination of the hardware and software.

The user terminal 10 is provided with an operation processing portion 30, a display portion 32, a communication portion 34, and a storage portion 36. The operation processing portion 30 receives a user operation. The operation processing portion 30 receives selection or input of, for example, the physical information on the user, the designation information of the target wearing item, the prediction condition, and the like. The display portion 32 displays information received from the virtual fitting server 20, i.e., information such as an avatar image, evaluation information, and recommendation information, which will be described later. The operation processing portion 30 receives, for example, an operation instruction in response to the information displayed on the display portion 32. The operation processing portion 30 and the display portion 32 may be integrally structured by, for example, a touch panel as hardware. The storage portion 36 stores, for example, physical information on the user, exercise data to be obtained when the user has actual performance a predetermined exercise including the target exercise, and information related to the user's preference. Details of these pieces of information will be described later.

The communication portion 34 transmits the information selected or input by the operation processing portion 30 and the information stored in the storage portion 36 to the virtual fitting server 20 via the network 18. The communication portion 34 receives information from the virtual fitting server 20 and sends the information to the display portion 32. The communication portion 34 may be configured by a wireless communication module of wireless LAN communication, mobile telephone communication, or the like, as hardware.

The virtual fitting server 20 is provided with a communication portion 40, an arithmetic portion 42, a storage portion 44, and an output unit 46. The communication portion 40 receives information transmitted from the user terminal 10 and sends the received information to the arithmetic portion 42. Also, the communication portion 40 transmits information such as an arithmetic result given by the arithmetic portion 42 to the user terminal 10. The communication portion 40 may be configured by a communication module of a wired LAN, etc., as hardware.

The arithmetic portion 42 executes arithmetic processing on the basis of the information received by the communication portion 40. Details of the arithmetic processing executed by the arithmetic portion 42 will be described later. The arithmetic portion 42 stores the arithmetic result in the storage portion 44. The arithmetic result stored in the storage portion 44 is output from the output unit 46 and transmitted to the user terminal 10 via the communication portion 40.

The wearing item information server 2 stores wearing item information regarding one or more kinds of wearing items including the target wearing item in association with identification information such as ID. The arithmetic portion 42 of the virtual fitting server 20 requests, via the communication portion 40, the wearing item information server 2 to transmit the wearing item information of the target wearing item on the basis of the designation information of the target wearing item received from the user terminal 10. The wearing item information server 2 transmits the wearing item information of the target wearing item to the virtual fitting server 20 in response to the request from the virtual fitting server 20. Details of the wearing item information will be described later.

The reference movement information server 4 stores information (hereinafter referred to as “reference movement information”) defining a standard movement of a person who does one or more kinds of exercise including the target exercise. The arithmetic portion 42 of the virtual fitting server 20 requests, via the communication portion 40, the reference movement information server 4 to transmit the reference movement information of the target exercise on the basis of the information related to a situation in which the target exercise is performed, i.e., the prediction condition, which has been received from the user terminal 10. The reference movement information server 4 transmits the reference movement information of the target exercise to the virtual fitting server 20 in response to the request from the virtual fitting server 20. Details of the reference movement information will be described later.

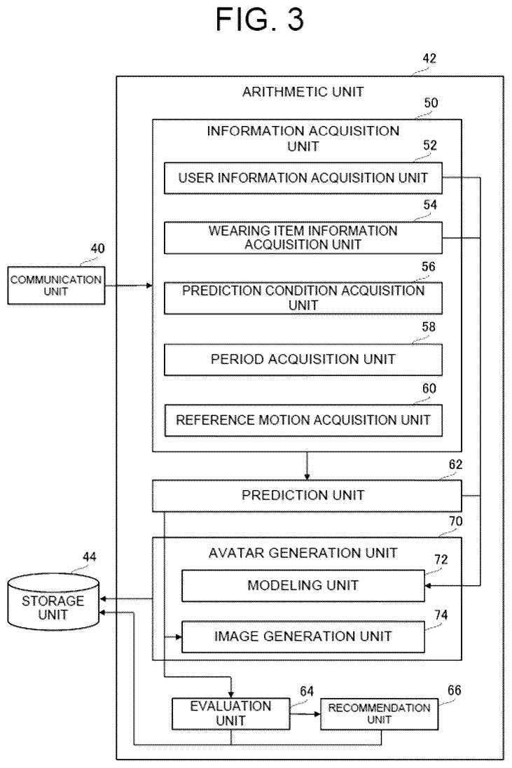

FIG. 3 is a functional block diagram showing a schematic configuration of the arithmetic portion 42 of the virtual fitting server 20. The arithmetic portion 42 is provided with an information acquiring unit 50, a prediction unit 62, an avatar generation unit 70, an evaluation portion 64, and a recommendation portion 66.

The information acquiring unit 50 is provided with a user information acquiring unit 52, a wearing item information acquiring unit 54, a prediction condition acquiring unit 56, a period acquiring unit 58, and a reference movement acquiring unit 60. The user information acquiring unit 52 acquires information related to the user of the user terminal 10.

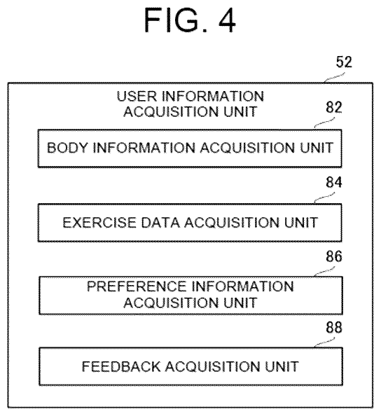

FIG. 4 is a functional block diagram showing a schematic configuration of the user information acquiring unit 52. The user information acquiring unit 52 of the present embodiment is provided with a physical information acquiring unit 82, an exercise data acquiring unit 84, a preference information acquiring unit 86, and a feedback acquiring unit 88.

The physical information acquiring unit 82 acquires physical information on the user. The physical information on the user includes, for example, the user's height, weight, body fat percentage, fasting or postprandial blood glucose level, body temperature, and the size and shape of the body part on which the target wearing item is worn. If the target wearing item is, for example, shoes or socks, the physical information on the user may include foot shape information such as a foot length and a foot circumference. If the target wearing item is, for example, clothes, the physical information on the user may include information on the body type. The physical information on the user may include information on the injury history of the body part on which the target wearing item is worn. The physical information acquiring unit 82 may read image information, such as a photograph of the entire body or a specific body part of the user, and specify the physical information on the user from the image information.

The exercise data acquiring unit 84 acquires exercise data. The exercise data to be acquired by the exercise data acquiring unit 84 may be data recorded when the user has actual performance the target exercise or may be data estimated from data recorded when the user has performed exercise other than the target exercise. Alternatively, the exercise data to be acquired may be data estimated from the physical information on the user. The target exercise may be any sports. In the present specification, the sports include not only competitive sports, the load of which is relatively high, such as running, ball games, swimming, cycling, skiing, snowboarding, and skateboarding, but also exercises, the load of which is relatively low, such as walking and stretching.

The exercise data may include various kinds of measurement data acquired when the user has actual performance the target exercise. The exercise data may include, for example, data relating to a movement measured by a movement sensor such as a nine-axis sensor. The exercise data may include biological data measured by a biological sensor such as a heart rate sensor or a body temperature sensor. The exercise data may include data such as positional coordinates and altitude measured by position information sensors such as a positioning sensor and an altitude sensor. The exercise data may include data such as temperature, atmospheric pressure, humidity, and wind velocity measured by environment sensors such as a temperature sensor and an atmospheric pressure sensor. The exercise data may include weather information acquired via the Internet or the like. The exercise data is not limited to data obtained by one-time measurement, but may be data measured a plurality of times when the user does one sequence of the target exercise. Alternatively, the exercise data may be data measure performed or more times at the time the user does each target exercise when he/she does the target exercise for a plurality of times.

In a case where the target exercise is running or walking, the exercise data may include, for example, a length of stride, a pitch (which refers to the number of steps per unit time, and is also referred to as a cadence), the intensity of a landing impact, a running or walking distance, a required time, a heart rate, a maximum oxygen intake, an analytical value related to a form, a running or walking route, a gained altitude, and the like.

The exercise data acquiring unit 84 may acquire exercise data from a server which manages already available applications or Internet services for recording the exercise data.

The preference information acquiring unit 86 acquires information related to a preference of the user. The information related to the preference of the user is information about the user's liking about the target wearing item. The information may include, for example, information about whether the user prefers a larger size or a smaller size, information about whether the user prefers a harder landing feel or a softer landing feel when the target wearing item is shoes, information about a preferred color, and information about a preferred design. The information related to the preference of the user may include wearing history information in which information on a wearing item worn by the user in the past is associated with information on the impression of the user who has worn the wearing item. The impression of the user may include information of a fitted feeling, information indicating a place which tends to wear out easily of the parts of the wearing item, and the like. The information related to the preference of the user may include information on the inclinations for the performance that is desired by the user for the target wearing item, i.e., information on whether the user places importance on the functionality of the wearing item in the target exercise or whether the user places importance on fashion of the wearing item, for example. The information related to the preference of the user may be information input by the user by using the user terminal 10, or may be information generated on the basis of a purchase history, a search history, or the like, of the wearing items of the user in the past. Alternatively, the information related to the preference of the user may be information generated through a sensitivity survey, a questionnaire, or the like. The information related to the preference of the user may be information estimated on the basis of information related to an action such as posting or activity on social media, and information related to the content of an account to be followed, etc.

The feedback acquiring unit 88 acquires feedback information input by the user after doing the target exercise by wearing another wearing item different from the target wearing item. Though details will be later, the feedback information is used by the prediction unit 62 to predict the user state, and can be utilized to improve the prediction accuracy.

Returning to FIG. 3, the wearing item information acquiring unit 54 acquires wearing item information related to characteristics of the target wearing item. For example, the target wearing items are those used for sports. The target wearing items include shoes, shoe insoles, socks, taping, compression wear, clothes, braces, supporters, and the like. The wearing item information may include various kinds of information such as the shape of the target wearing item, the quality of material for each part, the mass, the force of pressure at the worn part, the color, and the size, and other information which may affect the performance of the target exercise. The wearing item information acquiring unit 54 may acquire the wearing item information corresponding to the designation information (for example, the product number) of the target wearing item, which is to be received from the user terminal 10, from the wearing item information server 2.

The prediction condition acquiring unit 56 acquires, as a prediction condition, information related to a situation in which the target exercise is performed. The prediction condition is used as a condition to be used when the prediction unit 62 predicts the user state. The prediction condition may include information regarding an environment in which the target exercise is performed, information regarding the details of the exercise, and the like. For example, in a case where the target exercise is running, the prediction condition may include information on a track, e.g., information on whether the track is paved or unpaved, information on a climate, information on wind velocity, information on a running distance, information on a running pace, and the like. For example, in a case where the target exercise is soccer, the prediction condition may include information on a surface type of a soccer field, e.g., information on whether the soccer field is of natural grass, artificial grass, or soil.

The period acquiring unit 58 acquires information on a period. Though details will be described later, the information on the period acquired by the period acquiring unit 58 is used by the prediction unit 62 to generate post-wearing information. That is, the information on the period acquired by the period acquiring unit 58 is used as information on a predetermined period to be used when the prediction unit 62 predicts a post-exercise user state resulting after the user has continued the target exercise for a predetermined period by wearing the target wearing item.

The reference movement acquiring unit 60 acquires reference movement information. The reference movement information is information on a model of a movement defined for each type of the target exercise. For example, if the target exercise is running, the reference movement information may be information related to a human body model running in a standard form along a time axis. Though details will be described later, the reference movement information is used as a reference movement to be used when the prediction unit 62 predicts a user movement. The reference movement acquiring unit 60 may acquire the reference movement information corresponding to the target exercise designation information, which is to be received from the user terminal 10, from the reference movement information server 4.

The prediction unit 62 predicts, based on the physical information acquired by the physical information acquiring unit 82, the wearing item information acquired by the wearing item information acquiring unit 54, and the prediction condition acquired by the prediction condition acquiring unit 56, the user state resulting when the user does the target exercise by wearing the target wearing item.

The user state predicted by the prediction unit 62 may include information regarding various effects obtained by the user as he/she does the target exercise by wearing the target wearing item. The user state may include, for example, information related to physical properties of the target wearing item and information related to the body of the user, such as air permeability of the target wearing item, pressure applied to the wearing part, a temperature distribution, a load on the body, stress produced at the joints, a degree of fatigue of the muscles, and an amount of perspiration. The user state is information that can be used to evaluate the target wearing item.

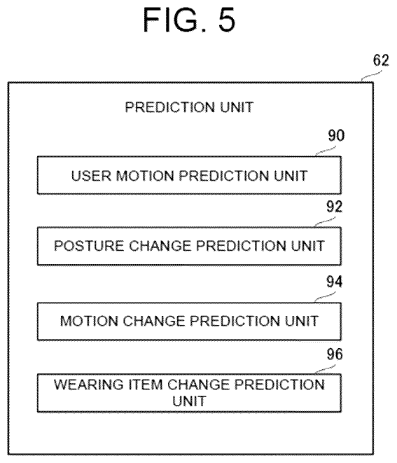

FIG. 5 is a functional block diagram showing a schematic configuration of the prediction unit 62. The prediction unit 62 of the present embodiment is provided with a user movement prediction unit 90, a posture change prediction unit 92, a movement change prediction unit 94, and a wearing item change prediction unit 96.

The user movement prediction unit 90 predicts, based on the wearing item information of the target wearing item acquired by the wearing item information acquiring unit 54, the exercise data acquired by the exercise data acquiring unit 84, and the reference movement information acquired by the reference movement acquiring unit 60, a user movement engaged when the user does the target exercise by wearing the target wearing item. The user movement predicted by the user movement prediction unit 90 is an example of the user state predicted by the prediction unit 62. The user movement is predicted based on each individual's physical functions. Actions they can be performed vary according to each user. Therefore, even in the same sport, the movements differ from one user to another.

Specifically, first, the user movement prediction unit 90 predicts the movement engaged when the user does the target exercise based on a difference between the reference movement information and the exercise data. Here, the exercise data may be used as a parameter for predicting a movement specific to the user by reflecting a habit or a feature of the user in a standard movement based on the reference movement information. Next, the user movement prediction unit 90 makes an adjustment based on the wearing item information of the target wearing item such that the predicted movement of the user conforms to a movement of a state in which the target wearing item is worn. For example, in a case where the target wearing item is shoes, if the mass of the shoes is greater than that of normal shoes, the pitch as the user movement may be decreased or the form may be changed. The degree of change in the user movement according to the wearing item information of the target wearing item may be varied depending on the exercise data. For example, the user movement may be more susceptible to the mass of the target wearing item as the muscle strength of the user is weaker.

The posture change prediction unit 92 predicts a change in the posture of the user caused by the user wearing the target wearing item and continuing the target exercise for a predetermined period. The movement change prediction unit 94 predicts a change in the user movement caused by the user wearing the target wearing item and continuing the target exercise for a predetermined period. The wearing item change prediction unit 96 predicts a change in the target wearing item caused by the user wearing the target wearing item and continuing the target exercise for a predetermined period.

In the present specification, the predetermined period may be a period acquired by the period acquiring unit 58 or may be a preset period. The preset period may be information on a period associated in advance with at least one of the target wearing item and the target exercise. The predetermined period may be varied depending on the target exercise, and may include, for example, a short period such as one sequence of exercise (one match, one race, or the like) to a long period such as several years. The “continuing the target exercise for a predetermined period” is not limited to continuing doing the target exercise without stopping, but includes habitually doing the target exercise. In addition, the predetermined period is not limited to a fixed period such as one hour, but may be a period of until a certain condition is satisfied, e.g., a period until one match is settled, a period until one race for running is finished, or the like.

The posture change prediction unit 92 predicts a change in the posture of the user based on the reference movement information acquired by the reference movement acquiring unit 60, the exercise data acquired by the exercise data acquiring unit 84, and the wearing item information of the target wearing item acquired by the wearing item information acquiring unit 54. For example, the posture change prediction unit 92 predicts, on the basis of the reference movement information and the exercise data, how much the posture of the user will be deformed by the user continuing the target exercise by wearing the target wearing item for a predetermined period. For example, the posture change prediction unit 92 predicts, on the basis of the reference movement information, the exercise data, and the wearing item information of the target wearing item, an influence that a change in a support function of the target wearing item exerts on a change in the posture of the user, which is to be obtained after the user has continued the target exercise for a predetermined period by wearing the target wearing item.

A plurality of parameters related to the exercise data and a plurality of parameters related to the wearing item information of the target wearing item may change individually or interactively in accordance with a continuation time of the target exercise. For example, in a case where the target exercise is running or walking, the exercise data includes a parameter for a length of stride and a parameter for a pitch. The parameter for a length of stride and the parameter for a pitch tend to decrease as the continuation time of the target exercise is increased. The exercise data of the user also includes information on an individual variation in the degree of temporal change of each parameter. That is, the degree of temporal change of the parameter for a length of stride and the degree of temporal change of the parameter for a pitch are different from each other according to each user. The wearing item information of the target wearing item includes a parameter for mass. The parameter for mass is constant regardless of the continuation time of the target exercise. However, as the parameter for mass increases, the user is more likely to be fatigued. Thus, the parameter for a length of stride and the parameter for a pitch, which are the parameters of the exercise data, may decrease. As described above, the posture change prediction unit 92 can predict a change in the posture of the user by using the information on a temporal change of each parameter. The same applies to the prediction of a change in the user movement to be made by the movement change prediction unit 94, and the prediction of a change in the target wearing item to be made by the wearing item change prediction unit 96.

For example, in a case where the target exercise is running, a change in the posture of the user is a change in the running form. The posture change prediction unit 92 predicts, for example, how much the hip will be lowered down and how much the upper body will lean forward, or the like, at a final phase of a long-distance race such as a marathon. The posture change prediction unit 92 may predict, as the change in the posture of the user, a change in the shape of the part where the target wearing item is worn, e.g., when the target wearing item is shoes, swelling of the feet or the like. The posture change prediction unit 92 may predict, on the basis of the reference movement information, the exercise data, and the wearing item information of the target wearing item, a change in the facial expression or the like of the user caused by the user wearing the target wearing item and continuing the target exercise for a predetermined period.

The movement change prediction unit 94 predicts a change in the user movement on the basis of the reference movement information acquired by the reference movement acquiring unit 60, the exercise data acquired by the exercise data acquiring unit 84, and the wearing item information of the target wearing item acquired by the wearing item information acquiring unit 54. For example, the movement change prediction unit 94 predicts, on the basis of the reference movement information and the exercise data, a change in the movement due to the fatigue of the user caused by the user continuing the target exercise by wearing the target wearing item for a relatively short period. For example, the movement change prediction unit 94 predicts, on the basis of the reference movement information, the exercise data, and the wearing item information of the target wearing item, an influence that the user's habituation or familiarity with the target wearing item exerts on the movement of the user, which is to be obtained after the user has continued the target exercise by wearing the target wearing item a relatively long period.

The wearing item change prediction unit 96 predicts a change in the target wearing item described above on the basis of the reference movement information acquired by the reference movement acquiring unit 60, the exercise data acquired by the exercise data acquiring unit 84, and the wearing item information of the target wearing item acquired by the wearing item information acquiring unit 54. For example, the wearing item change prediction unit 96 predicts, on the basis of the reference movement information, the exercise data, and the wearing item information of the target wearing item, a change in the elasticity of the target wearing item and a change in the properties such as a support force at a part that makes contact with the body of the user, which are caused by the user continuing the target exercise by wearing the target wearing item for a predetermined period. In a case where it is considered that the target wearing item does not change greatly in a short period of time, the wearing item change prediction unit 96 may predict that the target wearing item does not change if the predetermined period is a period that is shorter than or equal to a certain threshold period.

As described above, the posture change prediction unit 92, the movement change prediction unit 94, and the wearing item change prediction unit 96 respectively predict a change in the posture of the user, a change in the user movement, and a change in the target wearing item, which are caused by the user wearing the target wearing item and continuing the target exercise for a predetermined period. The prediction unit 62 predicts, on the basis of a prediction result of at least one of the change in the posture of the user, the change in the user movement, and the change in the target wearing item, which is caused by the user wearing the target wearing item and continuing the target exercise for a predetermined period, the post-exercise user state resulting after the user has continued the target exercise for a predetermined period by wearing the target wearing item. The post-exercise user state is an example of the user state. The post-exercise user state may be the same as the information of the above prediction result. The prediction unit 62 may predict, as the post-exercise user state, each of the stepwise changes in the user state resulting when the user continues the target exercise for a predetermined period. For example, in a case where the target exercise is running, when the predetermined period is a marathon in one race, the prediction unit 62 may predict each of the changes in the user state for each 5 km run by the user as the post-exercise user state.

The post-exercise user state may include information on a performance indicator of the target exercise. For example, if the target exercise is running, the information on the performance indicator may be an analytical value related to the running form or a predicted value of the time of a race, etc. The information on the performance indicator is not limited to an absolute value, but may be a relative value indicating how much the performance indicator will be changed in comparison with the other wearing items.

The post-exercise user state may include an indicator of a fitted feeling indicating how well the target wearing item is fitted to the user.

The prediction unit 62 may predict the user state further based on the feedback information acquired by the feedback acquiring unit 88. As described above, the feedback information is information related to feedback that has been input by the user after doing the target exercise by wearing another wearing item different from the target wearing item. As described above, as the prediction unit 62 predicts the user state further based on the feedback information, the feedback information supplements the physical information on the user, so that the prediction accuracy can be improved.

The user movement prediction unit 90 may correct, on the basis of a prediction result of at least one of the change in the posture of the user predicted by the posture change prediction unit 92, the change in the user movement predicted by the movement change prediction unit 94, and the change in the target wearing item predicted by the wearing item change prediction unit 96, the predicted user movement. Accordingly, the user movement prediction unit 90 can predict the user movement resulting after the user has continued the target exercise for a predetermined period by wearing the target wearing item.

The prediction by the prediction unit 62 may use a prediction model learned by machine learning. In this case, the prediction model outputs the user state including the user movement and the post-exercise user state when physical information, wearing item information, a prediction condition, exercise data, reference movement information, period information, and feedback information are input. Also, for the prediction by the prediction unit 62, an analytical method such as a regression analysis or a multivariate analysis may be used. In this case, the physical information, the wearing item information, the prediction condition, the exercise data, the reference movement information, the period information, and the feedback information may be assumed as the explanatory variables, and the user state including the user movement and the post-exercise user state may be assumed as the objective variables.

Returning to FIG. 3, the avatar generation unit 70 is provided with a modeling portion 72 and an image generation unit 74. The modeling portion 72 models an avatar on the basis of the physical information on the user. The avatar is a character represented in a virtual space as an alter ego of the user, and can be modeled by using a known technique. The avatar may represent the entire body of the user or a specific body part of the user, for example, a body part on which the target wearing item is worn, or may represent both of the above. The avatar may realistically represent the user or may represent the user by emphasizing the feature of the user. Further, the user may be represented in a simplified way by a stick figure or the like, or may be represented by a character such as an animal. The modeling portion 72 may model a part of the avatar, e.g., a face type, on the basis of information selected by the user.

The modeling portion 72 reflects the physical information on the user in the avatar. For example, when the avatar represents the entire body of the user, the modeling portion 72 models an avatar of the body type which corresponds to the height, weight, and body fat percentage, etc., of the user. For example, when the avatar represents a specific body part of the user, an avatar corresponding to the size of that body part of the user is modeled.

The modeling portion 72 may model an avatar also based on the wearing item information of the target wearing item in addition to the physical information on the user. In this case, the modeling portion 72 models an avatar in a state in which the target wearing item is worn. The avatar may change in accordance with the type, size, shape, color, etc., of the target wearing item.

The image generation unit 74 generates an avatar image in which the user state predicted by the prediction unit 62 is reflected in the avatar modeled by the modeling portion 72. For example, when the user state indicates information related to physical properties of the target wearing item, e.g., air permeability, pressure, a temperature distribution, or the like, the image generation unit 74 generates an avatar image in which a display mode, such as a color distribution for the body part on which the target wearing item is worn, is changed. For example, when the user state indicates information related to the body of the user, e.g., a degree of fatigue of the muscles, an amount of perspiration, or the like, the image generation unit 74 generates an avatar image in which a display mode such as a color distribution for the entire body or the body part or enlarged display of a target place is changed.

When the user state predicted by the prediction unit 62 is the post-exercise user state, the image generation unit 74 generates an avatar image in which the post-exercise user state is reflected. The avatar image reflecting the post-exercise user state may be displayed in a mode similar to that of the avatar image reflecting the user state described above. When the post-exercise user state predicted by the prediction unit 62 includes a plurality of stepwise changes in the user state, the image generation unit 74 may generate an avatar image corresponding to each of the changes in the user state.

When the user movement prediction unit 90 has predicted the user movement, the image generation unit 74 generates an avatar image to represent a situation of a case in which the avatar does the target exercise with the user movement. Accordingly, the image generation unit 74 can reflect, in the avatar image, information regarding how the user moves when the user does the target exercise by wearing the target wearing item.

The avatar image may be still image data, moving image data, or 3D modeling data. In a case where the avatar image is 3D modeling data, the avatar image may be converted into a data format that can be displayed when the avatar image is display-controlled on the user terminal 10 or the like after being output by the output unit 46. The image generation unit 74 may employ an image of the avatar viewed from a point of view of a third person as the avatar image, or an image from a point of view of the avatar as the avatar image. In a case where the avatar image is an image from a point of view of the avatar, an image of a view of the body part on which the target wearing item is worn, for example, is presented. By such an image, the user can easily imagine the user state to be brought about when wearing the wearing item.

The evaluation portion 64 generates evaluation information on the target wearing item on the basis of the user state predicted by the prediction unit 62. The evaluation portion 64 may evaluate information included in the information on the user state, e.g., each of pieces of information related to physical properties of the target wearing item and information related to the body of the user, and generate evaluation information including an evaluation of each item and a comprehensive evaluation. The evaluation information may include, for example, information on a score or a rank according to the comprehensive evaluation, and information on a score distribution according to the evaluation of each item. The evaluation information may be information displayed by a graph or a numerical value, or the image generation unit 74 described above may reflect the evaluation information in the avatar image. That is, for example, an expression of the avatar may be changed according to the comprehensive evaluation.

The recommendation portion 66 generates recommendation information indicating a wearing item recommended to be worn by the user on the basis of the wearing item information regarding each of a plurality of wearing items. In this case, the virtual fitting server 20 acquires the wearing item information regarding each of the plurality of wearing items by, for example, the following processing. The wearing item information acquiring unit 54 acquires the wearing item information for each of the plurality of wearing items from the wearing item information server 2. Here, the wearing item information to be acquired by the wearing item information acquiring unit 54 may be wearing item information designated as the target wearing item, or may be wearing item information that satisfies a predetermined condition in a case where the target wearing item is not designated. The prediction unit 62 predicts the user state for each of the plurality of wearing items. The evaluation portion 64 generates the evaluation information for each of the plurality of wearing items on the basis of the user state regarding each of the plurality of wearing items. On the basis of the evaluation information regarding each of the plurality of wearing items obtained in this way, the recommendation portion 66 may generate, for example, information on a wearing item with the highest comprehensive evaluation in terms of the evaluation information as the recommendation information for recommending the wearing to the user. Note that the image generation unit 74 may generate each of the avatar images in which the user state regarding each of the plurality of wearing items predicted by the prediction unit 62 is reflected. By doing so, the avatar images regarding the plurality of wearing items can be displayed at the same time, for example, to facilitate comparison of the wearing items.

Returning to FIG. 2, the storage portion 44 stores the arithmetic results such as the avatar images generated by the arithmetic portion 42. The storage portion 44 may store in advance information that the arithmetic portion 42 uses for the arithmetic operation.

The output unit 46 outputs the avatar image generated by the avatar generation unit 70. The output unit 46 may output information related to the user state predicted by the prediction unit 62 in a way other than by the avatar image, such as information represented by characters, numerical values, or graphs. However, outputting the avatar image is preferable in that the user can intuitively understand the user state. The output unit 46 may output the evaluation information generated by the evaluation portion 64. The output unit 46 may output the recommendation information generated by the recommendation portion 66. The information output by the output unit 46 is transmitted to the user terminal 10 via the communication portion 40.

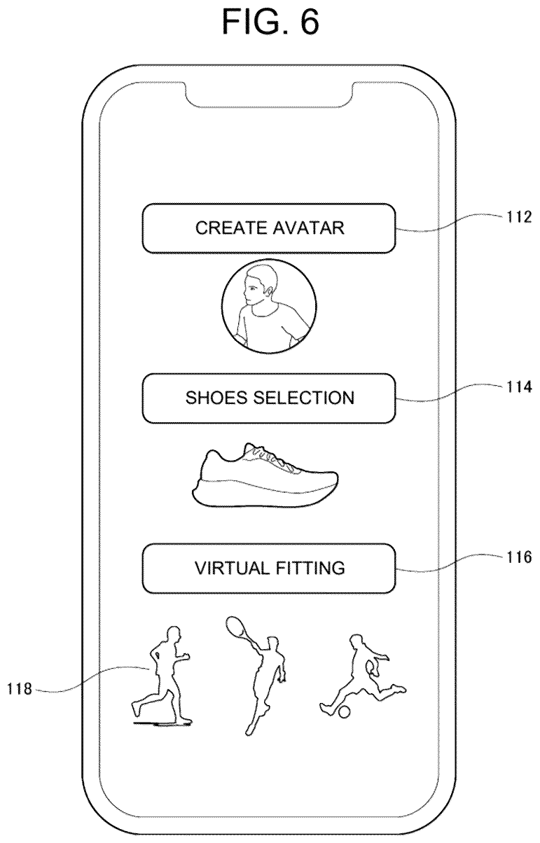

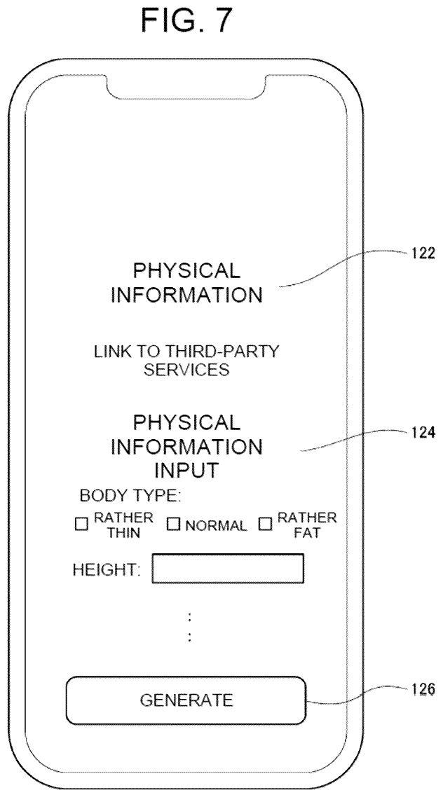

FIGS. 6 to 11 are examples of display screens displayed by the display portion 32 of the user terminal 10. FIG. 6 shows an example of a menu screen of a virtual fitting mode. When a “Create Avatar” image 112 illustrated in FIG. 6 is selected, the display portion 32 transitions to a display screen illustrated in FIG. 7.

FIG. 7 shows an example of a user information input screen. When a “Physical information Input” image 124 illustrated in FIG. 7 is selected, the user terminal 10 receives input of the physical information such as the body type and the height. When a “Measurement Information” image 122 illustrated in FIG. 7 is selected, the virtual fitting server 20 acquires the exercise data of the user from, for example, a server managing third-party services. When a “Generate” image 126 illustrated in FIG. 7 is selected, the user terminal 10 transmits the input physical information to the virtual fitting server 20, and the virtual fitting server 20 generates an avatar on the basis of the physical information and the exercise data.

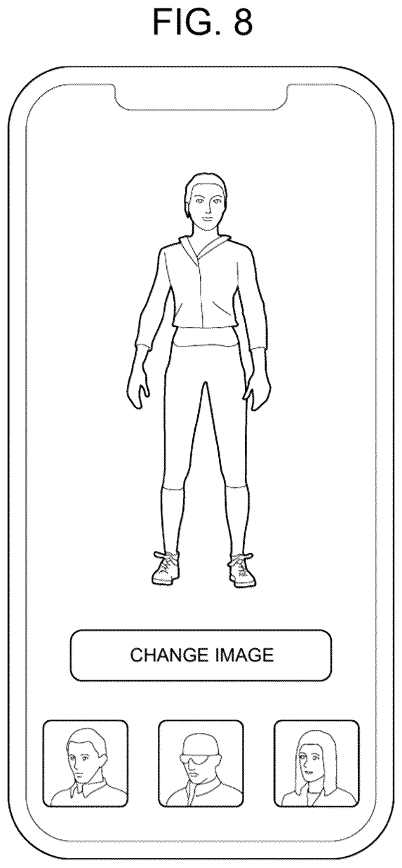

FIG. 8 shows an example of a selection screen for a face image included in an avatar. As illustrated in FIG. 8, the user may be able to change the face image included in the avatar.

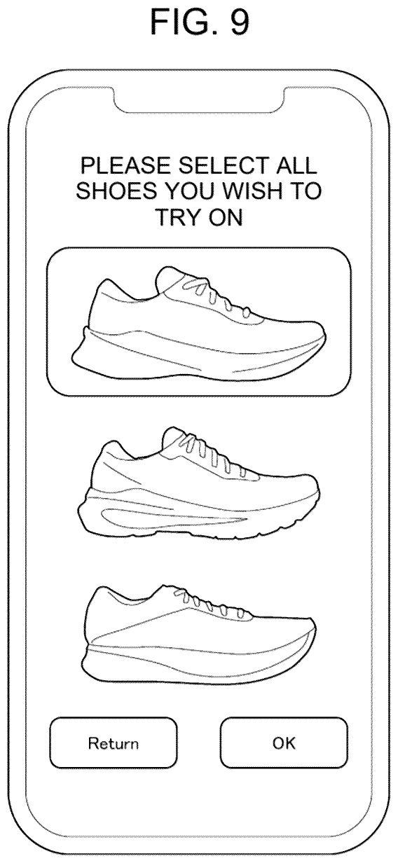

When a “Shoes Selection” image 114 illustrated in FIG. 6 is selected, the display portion 32 transitions to a display screen illustrated in FIG. 9. FIG. 9 shows an example of a selection screen for selecting a target wearing item. In FIG. 9, one or more shoes as the target wearing item are displayed to be selectable. The user terminal 10 transmits information designating the selected shoes as the target wearing item to the virtual fitting server 20.

Images corresponding to a plurality of types of exercise are displayed below a “Virtual Fitting” image 116 illustrated in FIG. 6. For example, when a running image 118 is selected, the user terminal 10 transmits information designating the target exercise as running to the virtual fitting server 20. The user terminal 10 further receives input of information related to a situation in which running is performed as the target exercise, and transmits the input information to the virtual fitting server 20 as the prediction condition.

The virtual fitting server 20 predicts, in the prediction unit 62, the user state resulting when the user wears the shoes designated as the target wearing item and performs running designated as the target exercise on the basis of the input physical information, wearing item information, and prediction condition. Further, the virtual fitting server 20 generates, in the avatar generation unit 70, an avatar image by reflecting the predicted user state in the avatar modeled on the basis of the physical information.

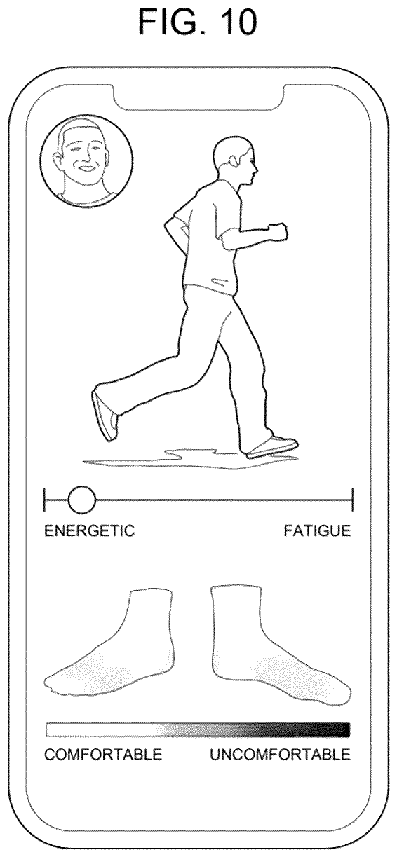

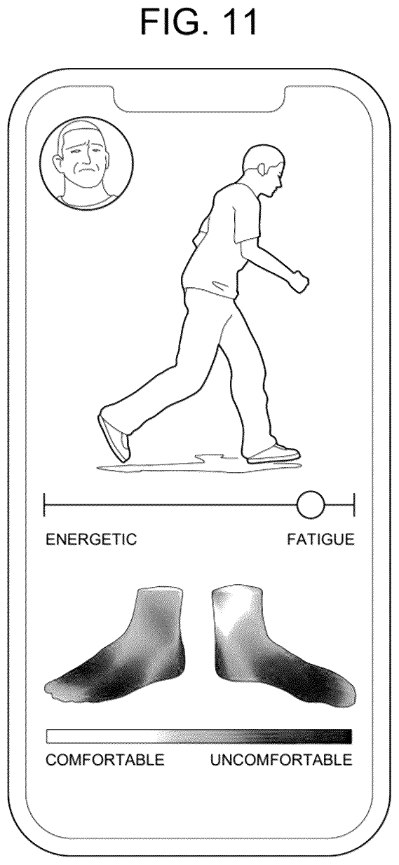

FIGS. 10 and 11 each show an example of a display screen which displays the generated avatar image. The figures indicate that when the user does the target exercise under the prediction condition, the target wearing item which constitutes the avatar image of FIG. 10 is better than the target wearing item which constitutes the avatar image of FIG. 11 in that the user is less likely to be fatigued, the form can be more stable, and the wearing item feels comfortable when worn.

Here, a specific example of using the virtual fitting system 100 of the present embodiment will be described. First, a case where the target exercise is soccer will be described. In this case, physical information on the user includes information on the height, the weight, and the foot shape. The target wearing item is shoes, and the wearing item information includes information on the materials and structures of an upper and an outsole. The prediction condition includes information on a surface type of a soccer field, e.g., information on whether the soccer field is of natural grass, artificial grass, or soil. In the present example, exercise data may not be used.

The prediction unit 62 of the present example predicts, as the user state, information on pressure applied to the feet and shoes at the time of a kick or step movement. The avatar generation unit 70 of the present example models at least one of the entire body and the feet as an avatar, and generates an avatar image in which the information on the pressure predicted by the prediction unit 62 is indicated by a change in color or the like. Consequently, it is possible to predict the magnitude of the load applied to the feet by the target wearing item.

Next, a case where the target exercise is running will be described. In this case, physical information on the user includes information on the height, the weight, and the foot shape. The exercise data includes information on an environment in which the exercise is performed and the movement. The target wearing item is shoes or running wear, and the wearing item information includes information on the size, material, and structure, if the target wearing item is shoes. The material includes information on the material of an upper and the material of a sole. The structure includes information on the structures of a last, a midsole, a shoelace, and the upper. In the case of sportswear, the wearing item information includes information on the size, a cutting pattern material of fabric. The prediction condition includes information such as the type of track, temperature, humidity, season, wind velocity, running distance, running speed, the type of running style, and hungry state.

The prediction unit 62 of the present example predicts, as the user state, information on a feeling of fatigue of the muscles, a load on the body, and the air permeability of the running wear. In addition, when both the shoes and the running wear, for example, are selected as the target wearing item, the prediction unit 62 also includes the influence of the interaction between the two in the user state. The avatar generation unit 70 of the present example models at least one of the entire body and the feet as an avatar, and generates an avatar image in which the information predicted by the prediction unit 62 is indicated by a change in color, a change in the size of the body part, or the like. Consequently, it is possible to predict a feeling of wearing in using the target wearing item over a medium-to-long period of time.

As described above, according to the present embodiment, the prediction unit 62 predicts, on the basis of the physical information, the wearing item information, and the prediction condition, the user state resulting when the user does the target exercise by wearing the target wearing item. The avatar generation unit 70 generates an avatar image in which the user state is reflected in the avatar modeled on the basis of the physical information. Consequently, it is possible to generate an avatar image in which the user state predicted in accordance with a situation in which a predetermined exercise is performed is reflected. Therefore, the user can intuitively and accurately evaluate the wearing item by looking at the avatar image.

Further, according to the present embodiment, the prediction unit 62 predicts, on the basis of the wearing item information, the exercise data, and the reference movement information, the user movement engaged when the user does the target exercise by wearing the target wearing item. The avatar generation unit 70 generates an avatar image to represent a situation of a case in which the avatar does the target exercise with the user movement. Consequently, since an avatar image representing the user movement in which the characteristics of the wearing item are reflected is generated, the user is able to understand how the wearing item affects the movement.

Furthermore, according to the present embodiment, the prediction unit 62 predicts, as the user state, a post-exercise user state resulting after the user has continued the target exercise for a predetermined period by wearing the target wearing item. More specifically, the prediction unit 62 predicts at least one of a change in the posture of the user, a change in the user movement, and a change in the target wearing item, which is caused by the user wearing the target wearing item and continuing the target exercise for a predetermined period, and predicts the post-exercise user state on the basis of a prediction result. Consequently, since it is possible to predict the state to be brought about after using the wearing item for a certain period of time, the wearing item can be evaluated more accurately.

The above-described embodiment may be a program for causing a computer to implement the function for realizing the above-described method, or may be a recording medium for storing the program. The recording medium for storing such a program may be a non-transitory and tangible computer-readable recording medium (storage medium). More specifically, the recording medium may be a magnetic recording medium, such as a non-volatile memory, a magnetic tape, or a magnetic disc, or an optical recording medium such as an optical disc.

The embodiments have been described above. It should be readily understood by those skilled in the art that the embodiments are merely examples, and various modifications can be made to combinations of the constituent elements and the processes for processing of the embodiments, and that such modifications are also within the scope of the present invention. In addition, when the above-described embodiments are generalized, the following aspects are obtained.

### [Aspect 1]

A virtual fitting apparatus comprising:
a user information acquiring unit which acquires physical information on a user;
a wearing item information acquiring unit which acquires wearing item information related to characteristics of a predetermined wearing item;
a prediction condition acquiring unit which acquires, as a prediction condition, information related to a situation in which a predetermined exercise is performed;
a prediction unit which predicts, based on the physical information, the wearing item information, and the prediction condition, a user state resulting when the user does the predetermined exercise by wearing the predetermined wearing item; and
an output unit which outputs information related to the user state.

According to the present aspect, the user state resulting when the user does the predetermined exercise by wearing the predetermined wearing item is predicted and output on the basis of the physical information on the user, the information related to the characteristics of the predetermined wearing item, and the information related to the situation in which the predetermined exercise is performed. Thus, it is possible to accurately evaluate the wearing item from the output user state.

### [Aspect 2]

The virtual fitting apparatus according to Aspect 1, further comprising an avatar generation unit which generates an avatar image in which the user state is reflected in an avatar modeled based on the physical information, wherein
the output unit outputs the avatar image.

According to the present aspect, since the avatar image in which the user state is reflected in the avatar based on the physical information on the user is generated and output, it is easy to intuitively understand the user state from the output avatar image.

### [Aspect 3]

The virtual fitting apparatus according to Aspect 2, wherein:
the user information acquiring unit further acquires exercise data to be obtained when the user has actual performance the predetermined exercise;
the virtual fitting apparatus further comprises a reference movement acquiring unit which acquires reference movement information defining a standard movement of a person who does the predetermined exercise;
the prediction unit predicts, based on the wearing item information, the exercise data, and the reference movement information, a user movement engaged when the user does the predetermined exercise by wearing the predetermined wearing item; and
the avatar generation unit generates the avatar image to represent a situation of a case in which the avatar does the predetermined exercise with the user movement.

According to the present aspect, it is possible to reflect, in the avatar image, a situation in which the user does the predetermined exercise by wearing the predetermined wearing item.

### [Aspect 4]

The virtual fitting apparatus according to Aspect 3, wherein
the prediction unit predicts, as the user state, a post-exercise user state resulting after the user has continued the predetermined exercise for a predetermined period by wearing the predetermined wearing item.

According to the present aspect, since it is possible to predict the state to be brought about after using the wearing item for a certain period of time, the wearing item can be evaluated more accurately.

### [Aspect 5]

The virtual fitting apparatus according to Aspect 4, wherein
the prediction unit predicts at least one of a change in a posture of the user, a change in the user movement, and a change in the predetermined wearing item, which is caused by the user wearing the predetermined wearing item and continuing the predetermined exercise for the predetermined period, and predicts the post-exercise user state based on a prediction result.

According to the present aspect, it is possible to predict the state to be brought about after using the wearing item for a certain period of time on the basis of a prediction result of at least one of the change in the posture of the user, the change in the user movement, and the change in the wearing item. Therefore, the wearing item can be evaluated more accurately.

### [Aspect 6]

The virtual fitting apparatus according to Aspect 4 or 5, wherein the post-exercise user state includes information on a performance indicator of the predetermined exercise.

According to the present aspect, since it is possible to predict the information on the performance indicator of the exercise to be obtained after using the wearing item for a certain period of time, the wearing item can be evaluated more accurately.

### [Aspect 7]

The virtual fitting apparatus according to any one of Aspects 4 to 6, wherein the post-exercise user state includes information on a fitted feeling of the predetermined wearing item.

According to the present aspect, since it is possible to predict the information on the fitted feeling of the wearing item to be obtained after using the wearing item for a certain period of time, the wearing item can be evaluated more accurately.

### [Aspect 8]

The virtual fitting apparatus according to any one of Aspects 4 to 7, further comprising a period acquiring unit which acquires information on a period, wherein
the prediction unit predicts the post-exercise user state by regarding the period acquired by the period acquiring unit as the predetermined period.

According to the present aspect, since it is possible to predict the state to be brought about after using the wearing item for a designated period of time, the wearing item can be evaluated more accurately.

### [Aspect 9]

The virtual fitting apparatus according to any one of Aspects 1 to 8, further comprising an evaluation portion which generates evaluation information on the predetermined wearing item based on the user state, wherein
the output unit further outputs the evaluation information.

According to present aspect, since the evaluation information on the wearing item is generated and output, the wearing item can be evaluated more objectively.

### [Aspect 10]

The virtual fitting apparatus according to Aspect 9, wherein:
the wearing item information acquiring unit acquires each of pieces of the wearing item information of a plurality of wearing items;
the prediction unit predicts the user state for each of the plurality of wearing items;
the evaluation portion generates the evaluation information for each of the plurality of wearing items based on the user state regarding each of the plurality of wearing items;
the virtual fitting apparatus further comprises a recommendation portion which generates recommendation information indicating a wearing item recommended to be worn by the user based on the evaluation information on each of the plurality of wearing items; and
the output unit further outputs the recommendation information.

According to the present aspect, since the recommendation information on the wearing item is generated and output, information on the wearing item suitable for the user can be provided.

### [Aspect 11]

The virtual fitting apparatus according to Aspect 9 or 10, wherein:
the user information acquiring unit further acquires preference information related to a preference of the user; and
the evaluation portion generates the evaluation information further based on the preference information.

According to the present aspect, since the evaluation information on the wearing item based on the information related to the preference of the user is generated and output, the accuracy of the evaluation information can be more improved.

### [Aspect 12]

The virtual fitting apparatus according to any one of Aspects 1 to 11, wherein:
the user information acquiring unit further acquires feedback information input by the user after doing the predetermined exercise by wearing another wearing item different from the predetermined wearing item; and
the prediction unit predicts the user state further based on the feedback information.

According to the present aspect, since the user state is predicted further based on the feedback information, the accuracy of prediction can be further improved.

### [Aspect 13]

A virtual fitting program for causing a computer to implement:
a function of acquiring physical information on a user;
a function of acquiring wearing item information related to characteristics of a predetermined wearing item;
a function of acquiring, as a prediction condition, information related to a situation in which a predetermined exercise is performed;
a function of predicting, based on the physical information, the wearing item information, and the prediction condition, a user state resulting when the user does the predetermined exercise by wearing the predetermined wearing item; and
a function of outputting information related to the user state.

According to the present aspect, the user state resulting when the user does the predetermined exercise by wearing the predetermined wearing item is predicted and output on the basis of the physical information on the user, the information related to the characteristics of the predetermined wearing item, and the information related to the situation in which the predetermined exercise is performed. Thus, it is possible to accurately evaluate the wearing item from the output user state.

What is claimed is:

1. A virtual fitting apparatus comprising:
a user information acquiring unit configured to acquire physical information of a user;
an item information acquiring unit configured to acquire item information related to a characteristic of a predetermined wearable item;
a prediction condition acquiring unit configured to acquire prediction condition information related to a situation in which a predetermined exercise is performed;
a prediction unit configured to predict, based on the physical information, the item information, and the prediction condition information, a user state as if the user had worn the wearable item and performed the predetermined exercise in the situation, even though the user has not actually performed the predetermined exercise; and
an output unit configured to output information related to prediction condition used to predict the user state.

2. The virtual fitting apparatus according to claim 1, further comprising an avatar generation unit configured to model an avatar based on the physical information and reflects the predicted user state onto the avatar,
wherein the output unit is configured to output the avatar.

3. The virtual fitting apparatus according to claim 2, wherein:
the user information acquiring unit is further configured to acquire exercise data obtained by the user performing the predetermined exercise;
the virtual fitting apparatus further comprises a reference movement acquiring unit configured to acquire reference movement information defining a standard movement of a person performing the predetermined exercise;
the prediction unit is configured to predict, based on the item information, the exercise data, and the reference movement information, a user movement as if the user had worn the wearable item and performed the predetermined exercise, even though the user has not actually performed the predetermined exercise; and
the avatar generation unit is configured to generate the avatar to represent the user movement.

4. The virtual fitting apparatus according to claim 3, wherein the prediction unit is further configured to predict, as the user state, a post-exercise user state as if the user had continued performing the predetermined exercise for a predetermined period with the predicted user movement while wearing the predetermined wearable item, even though the user has not actually performed the predetermined exercise.

5. The virtual fitting apparatus according to claim 4, wherein the post-exercise user state includes a change in a posture of the user, a change in the user movement, and a change in the predetermined wearable item.

6. The virtual fitting apparatus according to claim 4, wherein the post-exercise user state includes information on a performance indicator of the predetermined exercise.

7. The virtual fitting apparatus according to claim 4, wherein the post-exercise user state includes information on a fit of the predetermined wearable item.

8. The virtual fitting apparatus according to claim 4, further comprising a period acquiring unit configured to acquire information on a period of wearing the predetermined wearable item, wherein
the prediction unit is further configured to use the period acquired by the period acquiring unit as the predetermined period to predict the post-exercise user state.

9. The virtual fitting apparatus according to claim 1, further comprising an evaluation unit configured to generate evaluation information on the predetermined wearable item based on the user state, wherein
the output unit is further configured to output the evaluation information.

10. The virtual fitting apparatus according to claim 9, wherein:
the user information acquiring unit is further configured to acquire preference information related to a preference of the user regarding wearable items to wear; and
the evaluation unit is further configured to generates the evaluation information further based on the preference information.

11. The virtual fitting apparatus according to claim 1, wherein:
the user information acquiring unit is further configured to acquire feedback information from the user after wearing a wearable item different from the predetermined wearable item and performing the predetermined exercise; and
the prediction unit is configured to predict the user state based on the feedback information on the wearable item different from the predetermined wearable item, in addition to the physical information, the item information, and the prediction condition information.

12. A virtual fitting apparatus comprising:
a user information acquiring unit configured to acquire physical information of a user;
an item information acquiring unit configured to acquire item information related to characteristics of predetermined wearable items;
a prediction condition acquiring unit configured to acquire prediction condition information related to a situation in which a predetermined exercise is performed;
a prediction unit configured to predict, based on the physical information, the item information, and the prediction condition information, user states for the respective predetermined wearable items as if the user had worn the wearable items and performed the predetermined exercise in the situation, even though the user has not actually performed the predetermined exercise;
an evaluation unit configured to generate evaluation information regarding the predetermined wearable items based on the predicted user states for the respective predetermined wearable items;
a recommendation unit configured to generate recommendation information indicating one of the predetermined wearable items for the user to wear based on the evaluation information regarding the predetermined wearable items; and
an output unit configured to output the recommendation information.

13. The virtual fitting apparatus according to claim 12, wherein:
the user information acquiring unit is further configured to acquire preference information related to a preference of the user regarding wearable items; and
the evaluation unit generates the evaluation information based on the preference information in addition to the predicted user states for the respective predetermined wearable items.

14. A virtual fitting method comprising:
acquiring physical information on a user;
acquiring item information related to characteristics of a predetermined wearable item;
acquiring prediction condition information related to a situation in which a predetermined exercise is performed;
predicting a user state as if the user had worn the wearable item and performed the predetermined exercise in the situation, even though the user has not actually performed the predetermined exercise, based on the physical information, the item information, and the prediction condition information; and
outputting information related to the user state.
